(19) United States
(12) Patent Application Publication
(10) Pub. No.: US 2025/0385519 A1
(43) Pub. Date: Dec. 18, 2025

(54) Prioritization and Reservation of Power in Power over Ethernet and Fault Managed Power Systems

(71) Applicant: Cisco Technology, Inc., San Jose, CA (US)

(72) Inventors: Eric A. Voit, Bethesda, MD (US); Zhiyuan Yao, AMSTERDAM (NL); Joel Richard Goergen, Soulsbyville, CA (US); Beth Kochuparambil, Morgan Hill, CA (US); Kami Hurst, Sonora, CA (US); Ruqi Li, Fremont, CA (US)

(21) Appl. No.: 18/745,757

(22) Filed: Jun. 17, 2024

(51) Int. Cl. H02J 3/00; G06Q 30/0645

(52) U.S. Cl. CPC H02J 3/008; G06Q 30/0645

(57) ABSTRACT

Devices, networks, systems, methods, and processes for delivering power to a plurality of powered devices in a network are described herein. A controller may receive a lease request from a powered device. The controller can extract one or more requested parameters from the lease request. The controller can determine one or more device parameters associated with the powered device and one or more dynamic lease conditions associated with a power resource. If the one or more device parameters and/or the one or more requested parameters meet the one or more dynamic lease conditions, the controller can grant the lease request. The controller may deliver power to the powered device upon the grant of the lease request. The controller can dynamically update the one or more dynamic lease conditions and monitor the lease to check whether the lease complies with the one or more updated dynamic lease conditions.

The present disclosure relates to power distribution. More particularly, the present disclosure relates to prioritization and reservation of power delivered to devices in a network.

### BACKGROUND

Modern networks have a large number of interconnected devices. Since all the devices require power for functioning, efficient management of power distribution to the devices within a network has become increasingly important. Different devices are configured to perform different functions, and hence, may need different amounts of power. Furthermore, the functions may have different priorities in the network, for example, some devices may perform critical functions that are essential for functioning of the network, while other devices can perform functions that relate to supplementary services. Traditional power distribution networks provide power to all the devices at all times, without any differentiation. However, this may lead to inefficient distribution of power among the devices.

Some conventional networks manage power through static allocation of power to the devices. In modern networks, a total number of the devices in the network constantly varies due to external devices joining the network or existing devices leaving the network. In such cases, the conventional static allocation of power fails. Moreover, the conventional networks deliver power to the devices irrespective of factors such as real-time demand, device capabilities, and network conditions. This results into suboptimal power distribution, and hence, causes wastage of power resources.

Other conventional networks utilize strategies such as turning off the devices, operating the devices in power saving modes, or operating idle devices in sleep or hibernation modes. This can affect network performance. Further, the devices may consume power even in power saving modes, thereby leading to inefficient utilization of power. Another challenge arises from the devices utilizing power from the network without relinquishing the power when no longer needed. This can lead to resource contention and degradation of quality of service for other devices.

Therefore, there is a need for dynamic power allocation to the devices in the network to optimize the utilization of power.

### SUMMARY OF THE DISCLOSURE

Systems and methods for prioritization and reservation of power delivered to a plurality of powered devices in a network in accordance with embodiments of the disclosure are described herein. In some embodiments, a device includes a processor, and a memory communicatively coupled to the processor, wherein the memory includes a power delivery logic that is configured to receive a lease request from a powered device in a network, determine one or more device parameters associated with the powered device, identify one or more dynamic lease conditions associated with a power resource, grant the lease request if the one or more device parameters meet the one or more dynamic lease conditions, and deliver power to the powered device upon grant of the lease request.

In some embodiments, if the one or more device parameters fail to meet the one or more dynamic lease conditions, the power delivery logic is further configured to reject the lease request, or trigger renegotiation of the lease request with the powered device.

In some embodiments, the lease request is indicative of at least one of a requested power value, a requested power level, or a requested duration of a lease.

In some embodiments, granting the lease request includes reserving the requested power value from the power resource for the powered device for the requested duration of the lease.

In some embodiments, the requested power value is at a first power value during initialization of the powered device and the requested power value is at a second power value lower than the first power value after the initialization of the powered device.

In some embodiments, the requested power value is delivered to the powered device at the requested power level for the requested duration of the lease through a combined data/power interface upon the grant of the lease request.

In some embodiments, the combined data/power interface is an Ethernet port and the power is delivered to the powered device by way of Power-over-Ethernet through the Ethernet port.

In some embodiments, the power delivery logic is further configured to detect power demand associated with a plurality of powered devices in the network, monitor power consumption of the powered device, and detect one or more dynamic changes in the network.

In some embodiments, the power delivery logic is further configured to update the one or more dynamic lease conditions based on at least one of detected power demand, monitored power consumption, or the one or more dynamic changes in the network.

In some embodiments, the power delivery logic is further configured to revoke the grant of the lease request if the one or more device parameters fail to meet one or more updated dynamic lease conditions.

In some embodiments, the power delivery logic is further configured to revoke the grant of the lease request if the monitored power consumption exceeds the requested power value.

In some embodiments, the one or more device parameters include a device priority level associated with the powered device.

In some embodiments, the one or more dynamic lease conditions include one or more of a dynamic threshold priority level, a total available power, a maximum power level, or a maximum duration of the lease.

In some embodiments, a first dynamic lease condition of the one or more dynamic lease conditions is met if the device priority level exceeds the dynamic threshold priority level.

In some embodiments, a second dynamic lease condition of the one or more dynamic lease conditions is met if at least one of the requested power level is less than the maximum power level, the requested power value is less than the total available power, or the requested duration of the lease is less than the maximum duration of the lease.

In some embodiments, detecting the one or more dynamic changes in the network includes detecting oversubscription when the power demand exceeds the total available power.

In some embodiments, detecting the one or more dynamic changes in the network includes detecting at least one of addition or removal of one or more powered devices in the network.

In some embodiments, a power delivery logic is configured to determine a lease granted to a powered device, identify a power resource associated with the lease, determine one or more device parameters associated with the powered device, identify one or more dynamic lease conditions associated with the power resource, and determine whether the one or more device parameters meet the one or more dynamic lease conditions.

In some embodiments, if the one or more device parameters fail to meet the one or more dynamic lease conditions, the power delivery logic is further configured to revoke the lease, or trigger renegotiation of the lease with the powered device.

In some embodiments, a method includes receiving a lease request from a powered device in a network, determining one or more device parameters associated with the powered device, identifying one or more dynamic lease conditions associated with a power resource, granting the lease request if the one or more device parameters meet the one or more dynamic lease conditions, and delivering power to the powered device upon grant of the lease request.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network illustrating a point-to-point power delivery system, in accordance with various embodiments of the disclosure;

FIG. 2 is a conceptual illustration of a network illustrating a centralized controller in a power delivery system, in accordance with various embodiments of the disclosure;

FIG. 3 is a conceptual illustration of a network illustrating a plurality of distributed controllers, in accordance with various embodiments of the disclosure;

FIG. 4 is a conceptual network diagram of various environments that a power delivery controller may operate on a plurality of network devices, in accordance with various embodiments of the disclosure;

FIG. 5 is a flowchart depicting a process for a state diagram for power delivery, in accordance with various embodiments of the disclosure;

FIG. 6 is a flowchart depicting a process for granting a lease request, in accordance with various embodiments of the disclosure;

FIG. 7 is a flowchart depicting a process for monitoring an existing lease, in accordance with various embodiments of the disclosure; and

FIG. 8 is a conceptual block diagram of a device suitable for configuration with a power delivery logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods for prioritization and reservation of power delivered to a plurality of powered devices in a network in accordance with embodiments of the disclosure are described herein. In many embodiments, a network can include a plurality of powered devices. The powered devices may be connected to a power resource and/or a controller by way of a combined data/power interface. The combined data/power interface can be utilized to transmit and/or receive data to/from the powered devices and to deliver power to the powered devices. In some embodiments, the combined data/power interface can be one or more Ethernet ports. The Ethernet ports may facilitate delivering power to the powered devices by way of Power-over-Ethernet (POE) and to maintain Ethernet communication with the powered devices. In more embodiments, the power may be delivered by Fault Managed Power (FMP). The PoE or FMP can facilitate fault detection and safety while delivering the power. In certain embodiments, the PoE or FMP may be managed by one or more network protocols. The same network protocols can be utilized to manage the data transfer as well as the power delivery, thereby eliminating the need for different protocols for power delivery and data transfer.

In more embodiments, the PoE or FMP may be utilized to safely deliver DC power to the powered devices. In some more embodiments, one or more parameters of power delivery may be managed by the controller. In that, the controller can facilitate controlling one or more Quality of Service (QOS) parameters associated with the power delivery. In numerous embodiments, examples of the QoS parameters associated with the power delivery may include, but are not limited to, voltage levels, current levels, or load conditions etc. In many more embodiments, the network may include one or more power resources to supply power to the powered devices. In many further embodiments, examples of the power resources may include but are not limited to power sourcing equipment such as PoE switches, POE injectors, PoE splitters, network switches, repeaters, or industrial computers, etc. for example. The power resources may be directly or indirectly connected to the controllers and/or the powered devices. In many further embodiments, for example, the power can be delivered by the power resources by way of POE, PoE+, or PoE++ etc. at varied power levels, i.e., varied voltage and current levels. In even more embodiments, the examples of the powered devices may include but are not limited to sensors, Internet of Things (IoT) enabled devices, or actuators etc. In many more embodiments, the examples of the powered devices may include but are not limited to devices such as displays, lighting fixtures, home appliances, or computers, etc. In many further embodiments, the examples of the powered devices may include but are not limited to network devices such as switches, routers, gateways, or Access Points (APs) etc.

In a number of embodiments, for example, the controller can be a centralized controller. The centralized controller may be in communication with the plurality of powered devices in the network. The centralized controller can control the power delivered by the one or more power resources in the network. In some embodiments, for example, the controller may be a distributed controller. The network can include one or more distributed controllers, each associated with a group of powered devices. In certain embodiments, for example, the distributed controllers may be connected to different power resources. In more embodiments, for example, the distributed controllers can be connected to same power resources. In numerous embodiments, the controller and the power resource may be implemented in same device, thereby facilitating point-to-point power delivery. In many more embodiments, each powered device may be in communication with multiple controllers and/or multiple power resources. In many more embodiments, the network may comprise one or more clusters of powered devices. In that, in still many embodiments, for example, a distributed controller can manage power delivery to a cluster of powered devices.

In various embodiments, a controller may receive a lease request from a powered device. The lease request can be indicative of the powered device seeking to receive power from a power resource. In some embodiments, the lease request may be timed, i.e., the lease request may be valid only for a predetermined duration and may expire thereafter. In certain embodiments, the lease request may be indicative of one or more of: a requested power value, a requested power level, or a requested lease duration. In more embodiments, for instance, the requested power value may be indicative of an amount of power requested by the powered device. The requested power level can be indicative of one or more of: modes of power delivery, or voltage or current levels of power delivery etc. The requested lease duration may be indicative of a duration of time for which the powered device requests to lease the power resource, i.e., a duration of time for which the powered device requests to receive power from the power resource. In numerous embodiments, the lease request can be indicative of one or more QoS parameters associated with data transfer and/or power delivery. In some more embodiments, the powered device can generate and transmit the lease request dynamically or periodically. In many more embodiments, the powered device may generate and transmit the lease request to renegotiate the requested power value, the requested power level, the requested lease duration, or the QoS parameters. In many further embodiments, the powered device can generate and transmit the lease request upon detecting change in power requirements of the powered device, change in operational mode of the powered device, or any network changes detected by the powered device. In further embodiments, the powered device may generate and transmit the lease request when a previous lease request has been rejected by the controller. In even more embodiments, the powered device can generate and transmit the lease request to renegotiate previously requested power value, previously requested power level, or previously requested lease duration.

In additional embodiments, the controller can determine one or more device parameters associated with the powered device. In some embodiments, for example, the device parameters may be indicative of a priority level associated with the powered device. In certain embodiments, for example, the powered devices that implement network critical functions may have higher priority level than the powered devices that provide supplementary services. The controller can prioritize power allocation to the powered devices that implement the network critical functions over the powered devices that provide the supplementary services. In more embodiments, for example, the device parameters can be indicative of a device identifier associated with the powered device, type of the powered device, device name associated with the powered device, or other such parameters associated with the powered device. In some more embodiments, for example, the device parameters may be indicative of a protocol for data transfer or power delivery.

In many more embodiments, the controller may identify one or more dynamic lease conditions associated with the power resource. In some embodiments, the dynamic lease conditions can be indicative of a dynamic threshold priority level, a total available power, a maximum power level, or a maximum duration of the lease. In certain embodiments, for example, the powered devices having priority levels greater than the dynamic threshold priority level may be the powered devices that implement network critical functions. In more embodiments, the power resource can be reserved for the powered devices that implement network critical functions, thereby prioritizing the uninterrupted implementation of the network critical functions. In some more embodiments, the total available power can be indicative of maximum power that the power resource may supply, thereby limiting the power delivery to the powered devices that demand power equal or lesser than the total available power. In numerous embodiments, the maximum power level may be indicative of power delivery modes supported by the power resource. In many more embodiments, the maximum duration of the lease may be indicative of a maximum time period after which the leases to the power resource may be required to be renewed or renegotiated.

In many additional embodiments, the controller can grant the lease request if the one or more device parameters meet the one or more dynamic lease conditions. In numerous embodiments, the controller may compare the one or more device parameters and/or one or more requested parameters indicated in the lease request with the one or more dynamic lease conditions. In some embodiments, for example, a first dynamic lease condition may be met if the priority level associated with the powered device is greater than the dynamic threshold priority level. In certain embodiments, for example, a second dynamic lease condition can be met if the requested power value is less than the total available power. In more embodiments, for example, a third dynamic lease condition may be met if the requested power level is less than the maximum power level. In some more embodiments, a fourth dynamic lease condition can be met if the requested lease duration is less than the maximum duration of the lease.

In many further embodiments, the controller may reject the lease request if the one or more device parameters fail to meet the one or more dynamic lease conditions. In some embodiments, the controller can trigger renegotiation of the lease request if the one or more device parameters fail to meet the one or more dynamic lease conditions. In certain embodiments, the controller can transmit a renegotiation message to the powered device to trigger renegotiation. In more embodiments, the renegotiation message may be transmitted by utilizing one or more network protocols. In some more embodiments, the controller can transmit a power profile to the powered device by utilizing the network protocols. In many more embodiments, for example, the power profile can be indicative of grant of lease, rejection of lease, or renegotiation of the lease. In many additional embodiments, for example, the power profile can be indictive of one or more power delivery parameters. In that, the powered device may utilize the power delivery parameters to connect to the power resource and/or receive power from the power resource. In many further embodiments, the controller can reject the lease request when the renegotiation of the lease request fails for a predetermined number of times.

In still many embodiments, the controller may measure or determine a power demand associated with the powered devices. In some embodiments, for example, in the cluster of powered devices, the distributed controller can determine the power demand associated with the cluster of powered devices. The power demand can be indicative of the power required for functioning of the powered devices or the power requested by the powered devices. The controller can compare the power demand with the total available power associated with the one or more power resources in the network. If the power demand exceeds the total available power, the controller can detect oversubscription, i.e., a network condition where the power resources are restrained. In case of oversubscription, the controller can prioritize the powered devices having higher priority levels, and hence, reject the lease requests from the powered devices having lower priority levels. The controller can also monitor power consumption of the powered devices. In that, the controller may receive and analyze telemetry data associated with the powered devices. The telemetry data can be indicative of the power consumption of the powered devices. The telemetry data may be received in real-time or in near-real time. The telemetry data can also be received periodically at predetermined intervals. The controller may also receive the telemetry data dynamically. In some embodiments, the controller can receive the telemetry data from the powered devices or may retrieve the telemetry data from a database. If the controller detects that the power consumption of any powered device exceeds the requested value indicated by the lease request corresponding to the powered device, the controller can revoke the lease request, or trigger renegotiation of the lease request associated with the powered device. The controller may also detect one or more dynamic changes in the network. In some embodiments, the powered devices may be mobile devices such as, but not limited to laptops, smartphones, tablets, portable appliances, or smart wearable devices etc. Such mobile devices can be easily added to the network or disconnected from the network, thereby causing dynamic changes in the network. The controller can detect a dynamic change in the network caused by addition or removal of the powered devices. The controller may update the one or more dynamic lease conditions based on one or more of: the monitored power consumption, the dynamic changes in the network, the detected power demand, or the detected oversubscription. Upon updating the dynamic lease conditions, the controller can recheck one or more existing leases to determine whether the one or more existing leases are in compliance with the updated dynamic lease conditions. If the controller determines that any existing lease is not in compliance with the updated dynamic lease conditions, the controller can revoke the lease or trigger renegotiation of the lease. The controller may also revoke the lease after expiration of the requested duration of the lease indicated by the lease request. In that, the controller can monitor the existing leases constantly, dynamically, or periodically.

In still further embodiments, upon grant of the lease request to the powered device, the controller can reserve the requested power value from the power resource for delivering power to the powered device. The requested power value can vary based on an operational mode of the powered device. In some embodiments, for instance, the controller can reserve a higher power value for the device during initialization. In that, the powered devices may be delivered higher power to ensure that the powered devices boot. In certain embodiments, for example, the controller can lower the reserved power after the initialization of the powered device. That is, in more embodiments, the requested power value can be at a first power value during initialization of the powered device and the requested power value may be at a second power value lower than the first power value after the initialization of the powered device.

Advantageously, upon grant of the lease request, the controller can allocate, reserve, and deliver the requested power value from the power resource for the requested duration of the lease indicated by the lease request. This reservation may ensure that the powered device will have access to the requested power value during the requested duration of the lease, thereby eliminating contention with other powered devices for the same power resource. Initially, when the powered device is initialized or powered on, the powered device may require a higher amount of power to boot up, establish connections, and perform initialization tasks. A higher initial power commitment by the controller can ensure successful initialization of the powered device. Lowering the power commitment during steady-state operation of the powered device may save power, and thereby effectively utilize the total available power. The controller can revoke the leases associated with the supplementary services without affecting the network critical functions, thereby ensuring safety and uninterrupted connectivity. The controller may dynamically adjust power allocation to the powered devices to accommodate the dynamic changes in the network, and hence, ensure stability of the network.

More advantageously, the centralized controller can facilitate implementation of same power delivery policies throughout the network. The centralized controller may also facilitate casier configuration and management of the power delivery policies by providing a single point of control. Furthermore advantageously, the distributed controllers can be more resilient to failures, since the failure of one distributed controller may not disrupt the network or other distributed controllers. The distributed controllers can also facilitate casier scalability of the network. The distributed controllers can be closer to the powered devices, thereby reducing latency, reducing power losses in cables, and improving responsiveness of the power delivery.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

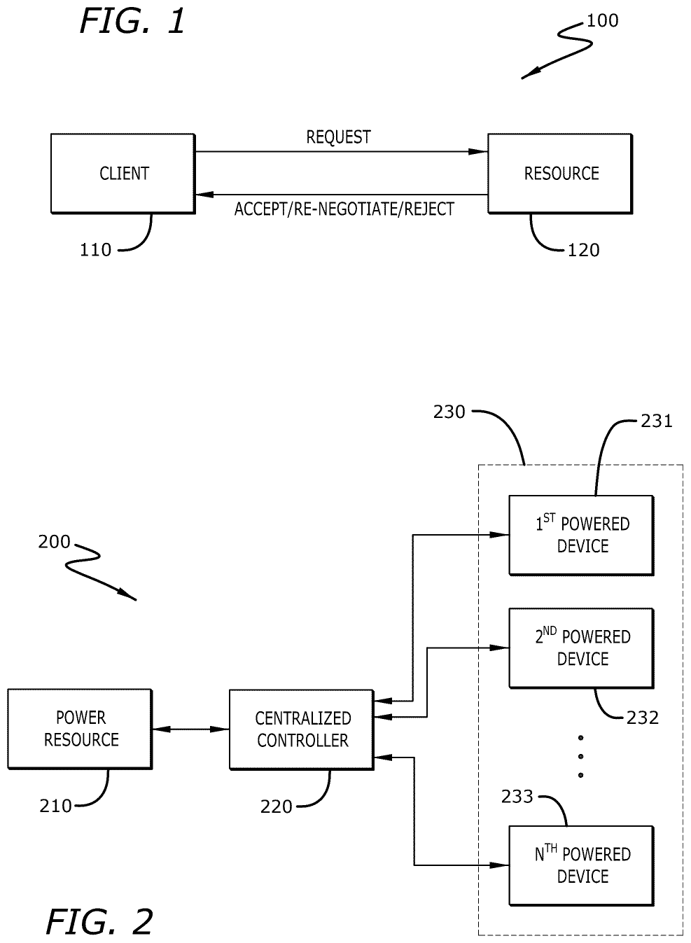

Referring to FIG. 1, a conceptual illustration of a network 100 illustrating a point-to-point power delivery system, in accordance with various embodiments of the disclosure is shown. In many embodiments, the network 100 may comprise a client device 110 and a power resource 120. The client device 110 may be a powered device. In some embodiments, examples of the client device 110 include but are not limited to sensors, Internet of Things (IoT) enabled devices, or actuators etc. In certain embodiments, the examples of the client device 110 may include but are not limited to devices such as displays, lighting fixtures, home appliances, or computers, etc. In more embodiments, the examples of the client device 110 may include but are not limited to network devices such as switches, routers, gateways, or Access Points (APs) etc. The client device 110 may be connected to the power resource 120 by way of a combined data/power interface. The combined data/power interface can be utilized to transmit and/or receive data to/from the client device 110 and to deliver power to the client device 110. In some embodiments, the combined data/power interface can be one or more Ethernet ports. The Ethernet ports may facilitate delivering power to the client device 110 by way of Power-over-Ethernet (POE) and to maintain Ethernet communication with the client device 110. In more embodiments, the power may be delivered by Fault Managed Power (FMP). The PoE or FMP can facilitate fault detection and safety while delivering the power. In certain embodiments, the PoE or FMP may be managed by one or more network protocols. The same network protocols can be utilized to manage the data transfer as well as the power delivery, thereby eliminating the need for different protocols for power delivery and data transfer. In more embodiments, the PoE or FMP may be utilized to safely deliver DC power to the client device 110. In some more embodiments, examples of the power resource 120 may include but are not limited to power sourcing equipment such as PoE switches, PoE injectors, PoE splitters, network switches, repeaters, or industrial computers, etc. for example.

Although a specific embodiment for the network 100 for carrying out the various steps, processes, methods, and operations described herein is discussed with respect to FIG. 1, any of a variety of systems and/or processes may be utilized in accordance with embodiments of the disclosure. For example, the client device 110 can be connected to multiple power resources including the power resource 120 simultaneously. The elements depicted in FIG. 1 may also be interchangeable with other elements of FIGS. 2-8 as required to realize a particularly desired embodiment.

Referring to FIG. 2, a conceptual illustration of a network 200 illustrating a centralized controller in a power delivery system, in accordance with various embodiments of the disclosure is shown. In many embodiments, the network 200 may comprise a power resource 210, a centralized controller 220, and a plurality of powered devices 230. The plurality of powered devices 230 can include first through N^{th} powered devices 231-233.

In a number of embodiments, the centralized controller 220 may be in communication with the plurality of powered devices 230 in the network 100 as well as the power resource 210. The centralized controller 220 can control the power delivered by the power resource 210. The centralized controller 220 may receive a plurality of lease requests from the plurality of powered devices 230. The centralized controller 220 may extract one or more requested parameters from the plurality of lease requests. The requested parameters can include a requested power value, a requested power level, and/or a requested lease duration. The centralized controller 220 can determine one or more device parameters associated with the plurality of powered devices 230. The centralized controller 220 may determine one or more dynamic lease conditions associated with the power resource 210. The centralized controller 220 can compare, for each powered device of the plurality of powered devices 230, whether one or more device parameters and requested parameters meet the one or more dynamic lease conditions. If the one or more device parameters and requested parameters meet the one or more dynamic lease conditions, the centralized controller 220 may grant the lease request associated with the powered device. The centralized controller 220 can reserve, from the power resource 210, the requested power value indicated by the granted lease request. Thereafter, the centralized controller 220 may deliver the requested power to the powered device upon the grant of the lease.

In various embodiments, if the centralized controller 220 determines that the one or more device parameters or requested parameters fail to meet the one or more dynamic lease conditions, the centralized controller 220 may reject the lease request. In some embodiments, the centralized controller 220 can trigger renegotiation of the lease request. In certain embodiments, the centralized controller 220 can transmit a renegotiation message to the powered device to trigger renegotiation. In more embodiments, the renegotiation message may be transmitted by utilizing one or more network protocols. In some more embodiments, the centralized controller 220 can transmit a power profile to the powered device by utilizing the network protocols. In many more embodiments, for example, the power profile can be indicative of grant of lease, rejection of lease, or renegotiation of the lease. In many additional embodiments, for example, the power profile can be indictive of one or more power delivery parameters. In that, the powered device may utilize the power delivery parameters to connect to the power resource 210 and/or receive power from the power resource 210. In many further embodiments, the centralized controller 220 can reject the lease request when the renegotiation of the lease request fails for a predetermined number of times.

Although a specific embodiment for the network 200 for carrying out the various steps, processes, methods, and operations described herein is discussed with respect to FIG. 2, any of a variety of systems and/or processes may be utilized in accordance with embodiments of the disclosure. For example, the centralized controller 220 may dynamically monitor the leases associated with the plurality of powered devices 230. The elements depicted in FIG. 2 may also be interchangeable with other elements of FIG. 1 and FIGS. 3-8 as required to realize a particularly desired embodiment.

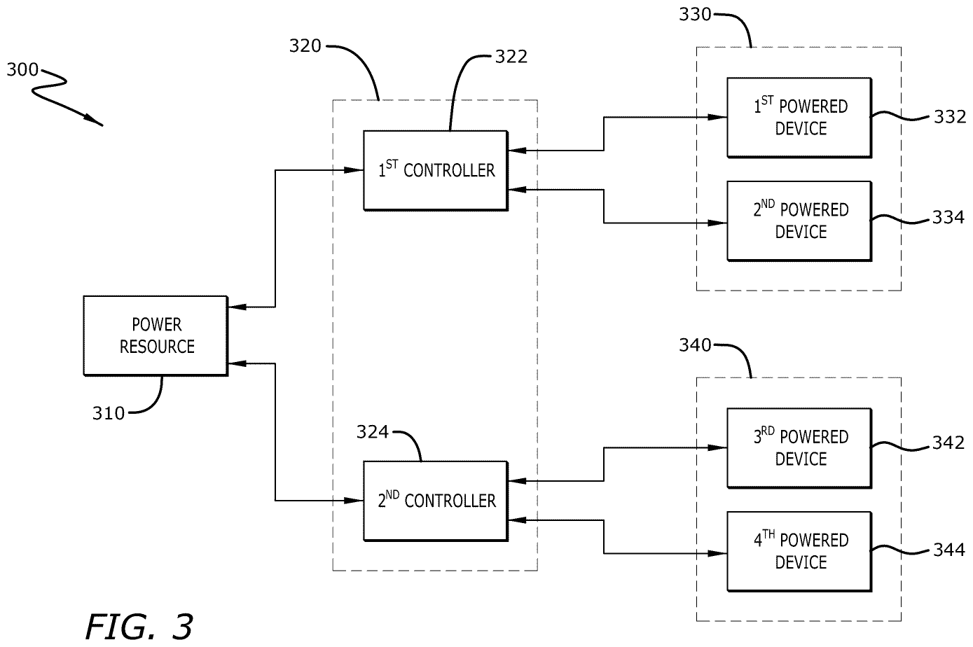

Referring to FIG. 3, a conceptual illustration of a network 300 illustrating a plurality of distributed controllers 320 in a power delivery system, in accordance with various embodiments of the disclosure is shown. In many embodiments, the network 300 may comprise a power resource 310, the plurality of distributed controllers 320, and a plurality of powered devices. The plurality of powered devices can include one or more clusters of powered devices. The one or more clusters of powered devices may include a first cluster of powered devices 330 and a second cluster of powered devices 340. The first cluster of powered devices 330 can include one or more powered devices including a first powered device 332 and a second powered device 334. The second cluster of powered devices 340 may include one or more powered devices including a third powered device 342 and a fourth powered device 344. The plurality of distributed controllers 320 can include a first controller 322 and a second controller 324.

In a number of embodiments, the first controller 322 may be associated with the first cluster of powered devices 330 and the second controller 324 can be associated with the second cluster of powered devices 340. The first and second controllers 322-324 may determine one or more dynamic lease conditions associated with the power resource 310. The first controller 322 can receive first and second lease requests from the first and second powered devices 332-334. The first controller 322 can retrieve requested parameters from the first and second lease requests. The first controller 322 may determine device parameters associated with the first and second powered devices 332-334 and decide the first and second lease requests based on the one or more dynamic lease conditions. Similarly, the second controller 324 can receive third and fourth lease requests from the third and fourth powered devices 342-344. The second controller 324 can retrieve requested parameters from the third and fourth lease requests. The second controller 324 may determine device parameters associated with the third and fourth powered devices 342-344 and decide the third and fourth lease requests based on the one or more dynamic lease conditions.

Although a specific embodiment for the network 300 for carrying out the various steps, processes, methods, and operations described herein is discussed with respect to FIG. 3, any of a variety of systems and/or processes may be utilized in accordance with embodiments of the disclosure. For example, the plurality of distributed controllers 320 may be associated with different power resources. The elements depicted in FIG. 3 may also be interchangeable with other elements of FIGS. 1-2 and FIGS. 4-8 as required to realize a particularly desired embodiment.

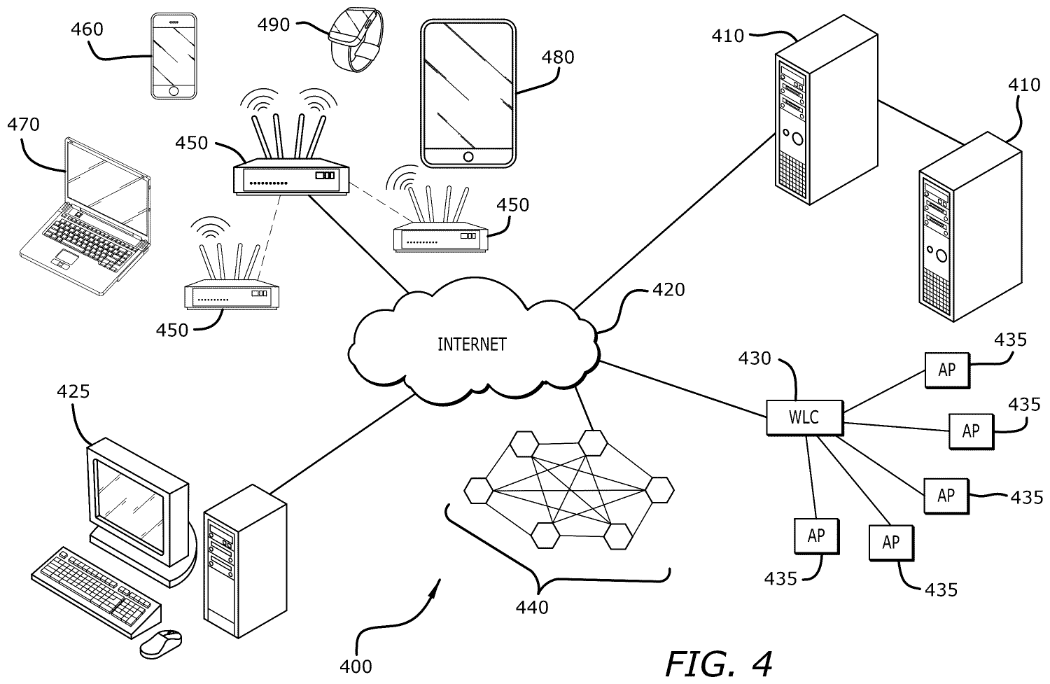

Referring now to FIG. 4, a conceptual network diagram 400 of various environments that a power delivery controller may operate on a plurality of network devices in accordance with various embodiments of the disclosure is shown. The power delivery controller may operate on one or more servers 410 connected to a network 420. The network 420 can be a wired network or a wireless network. In many embodiments, the network 420 may be a Wi-Fi network. Those skilled in the art will recognize that the power delivery controller can be comprised of various hardware and/or software deployments and can be configured in a variety of ways. In many non-limiting examples, the power delivery controller can be configured as a standalone device, exist as a logic in another network device, be distributed among various network devices operating in tandem, or remotely operated as part of a cloud-based network management tool. In further embodiments, the servers 410 can be configured with or otherwise operate a power delivery controller. The power delivery controller can be provided as a cloud-based service that can service remote networks, such as, but not limited to a deployed network 440. In many embodiments, the power delivery controller can be a logic that decides on granting lease requests and delivering power from power resources as per the granted lease requests.

However, in additional embodiments, the power delivery controller may be operated as a distributed logic across multiple network devices. In the embodiment depicted in FIG. 4, a plurality of network access points (APs) 450 can operate as the power delivery controller in a distributed manner or may have one specific device operate as the power delivery controller for all of the neighboring or sibling APs 450. That is, the APs 450 may be power delivery enabled APs. The power delivery enabled APs can facilitate power delivery for various electronic devices, such as but not limited to mobile computing devices including laptop computers 470, cellular phones 460, portable tablet computers 480 and wearable computing devices 490.

In further embodiments, the power delivery controller may be integrated within another network device. In the embodiment depicted in FIG. 4, a wireless LAN controller (WLC) 430 may have an integrated power delivery controller that the WLC 430 can use to deliver power to the various APs 435 that the WLC 430 is connected to, either wired or wirelessly.

Although a specific embodiment for various environments that the power delivery controller may operate on a plurality of network devices suitable for carrying out the various steps, processes, methods, and operations described herein is discussed with respect to FIG. 4, any of a variety of systems and/or processes may be utilized in accordance with embodiments of the disclosure. In many non-limiting examples, the power delivery controller may be provided as a device or software separate from the devices or the power delivery controller may be integrated into the devices. The elements depicted in FIG. 4 may also be interchangeable with other elements of FIGS. 1-3 and 5-8 as required to realize a particularly desired embodiment.

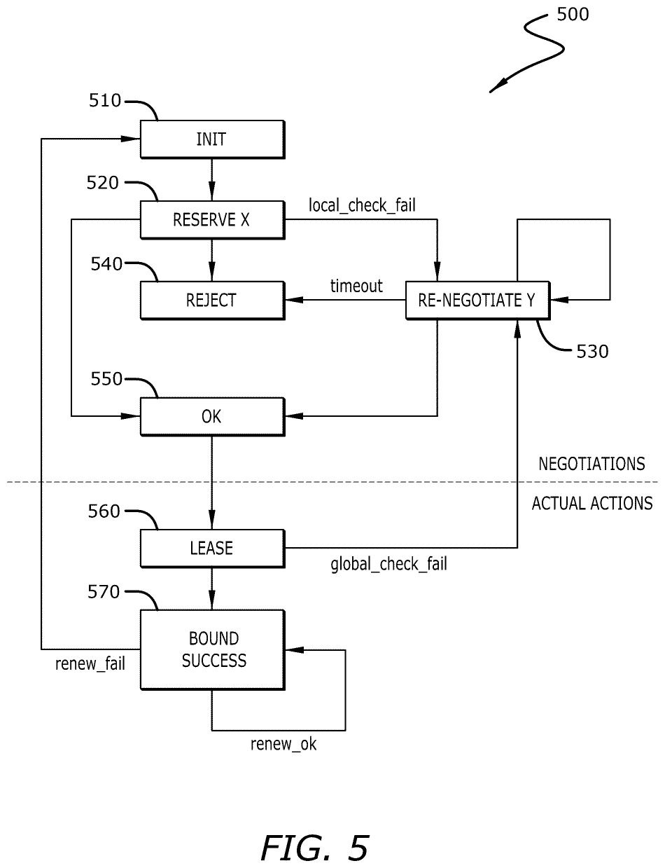

Referring now to FIG. 5, a flowchart depicting a process 500 of a state diagram for power delivery, in accordance with various embodiments of the disclosure is shown. In many embodiments, the process 500 can utilize one or more network protocols for power reservation and/or power allocation to one or more powered devices. In some embodiments, the process 500 may utilize one or more proprietary protocols for the power reservation and/or power allocation. In certain embodiments, the proprietary protocols and/or the network protocols may be utilized to manage both: data transfer to/from the powered devices and power delivery to the powered devices.

In a number of embodiments, the process 500 may implement a protocol similar to Dynamic Host Configuration Protocol (DHCP) or an enhanced DHCP protocol for the power allocation and/or power reservation. In the context of power reservation, one or more DHCP leases can be utilized to allocate power and manage power delivery by the power resources to the powered devices. In addition to assigning Internet Protocol (IP) addresses to the powered devices in response to the DHCP leases, a DHCP server may also grant leases for power usage to the powered devices, for delivering power by way of PoE or FMP. When the powered device connects to the network, the powered device can send an enhanced DHCP lease request to the DHCP server, indicating its need for both: an IP address and the requested power value. The DHCP server may respond by granting the enhanced lease request for both: the IP address and the requested power value. An enhanced lease may specify the duration of the lease for which the powered device can be allowed to utilize the assigned IP address and the allocated power. The enhanced lease can have a predetermined or pre-negotiated duration, after which the enhanced lease may expire and can be renewed thereafter.

In various embodiments, the process 500 can utilize Change of Authorization (CoA) provided by Remote Authentication Dial-In User Service (RADIUS) for dynamically modifying the lease requests. The RADIUS CoA can be utilized for power reservation and/or power allocation, where dynamic adjustments to the power allocation and/or power reservation are required for the powered devices. In addition to changing access permissions provided by RADIUS, the reserved power and/or the allocated power for the powered devices may also be modified based on updated dynamic lease conditions. In some embodiments, RADIUS CoA can enable real-time modification and/or renegotiation of the leases by facilitating the controller to transmit commands or messages to the power resources to adjust the power delivery to the powered devices. In certain embodiments, for example, if the powered device requires additional power, the controller can send a CoA message instructing the power resource to increase the power delivery to the powered device. RADIUS CoA can also facilitate dynamic power management policies by allowing network administrators to change power allocation policies for individual powered devices or the clusters of powered devices in real-time or in near-real time.

In additional embodiments, the process 500 can utilize an enhanced Apache Kafka Rebalance Protocol. In addition to message partition rebalancing, the enhanced Rebalance Protocol can dynamically manage power allocation among the powered devices. The process 500 may implement a dynamic rebalancing mechanism. In that, the powered devices could negotiate and adjust the power received from the power resource. In further embodiments, the process 500 may utilize an enhanced Data Over Cable Service Interface Specification (DOCSIS) protocol. In that, the process 500 may facilitate dynamic usage tuning for the power reservation and/or power allocation by negotiating and leasing power resources over a shared PoE connection with multiple powered devices. In still more embodiments, the process 500 may utilize an enhanced Dynamic Bandwidth Allocation (DBA) protocol. In that, the process 500 can facilitate power reservation by enabling variable power allocation based on demand from the powered devices and availability of power resources.

In many embodiments, the process 500 can detect connection with the powered devices (block 510). In that, in some embodiments, the process 500 may facilitate higher initial power commitment to the powered devices during the initialization or booting of the powered devices. In certain embodiments, the power commitment can be lowered after initialization or during steady-state operation of the powered devices. In more embodiments, the process 500 may receive the lease request from the powered device.

In a number of embodiments, the process 500 may decide the lease request (block 520). In some embodiments, the process 500 can determine device parameters associated with the powered device. In numerous embodiments, the process 500 may extract the requested parameters from the lease request. In certain embodiments, the process 500 may compare the device parameters and/or the requested parameters with the dynamic lease conditions. In more embodiments, the process 500 can reserve the requested power if the device parameters and/or the requested parameters meet the dynamic lease conditions.

In various embodiments, the process 500 can trigger renegotiation of the lease request if the device parameters fail to meet the dynamic lease conditions (block 530). In some embodiments, the process 500 may generate and transmit the renegotiation message to the powered device to trigger renegotiation. In certain embodiments, the renegotiation message may be transmitted by utilizing one or more network protocols.

In additional embodiments, the process 500 may reject the lease request if the device parameters fail to meet the dynamic lease conditions (block 540). In some embodiments, the process 500 can reject the lease request if the renegotiation times out, i.e., the renegotiation is not completed in a predetermined amount of time. In certain embodiments, the process 500 may reject the lease request if renegotiation requests are rejected a predetermined number of times.

In further embodiments, the process 500 can allocate the power to the powered devices upon the grant of the lease request (block 550). In some embodiments, the power can be allocated based on the requested power value. In certain embodiments, the requested power value can be at a first power value during initialization of the powered device and the requested power value may be at a second power value lower than the first power value after the initialization of the powered device.

In many more embodiments, the process 500 may lease the power resource to the powered device (block 560). In some embodiments, the process 500 can monitor the lease. In certain embodiments, the process 500 may recheck the leases based on the update dynamic lease conditions. In more embodiments, if the lease does not comply with the updated dynamic lease conditions, the process 500 can trigger renegotiation of the lease. In some more embodiments, the process 500 may trigger renewal of the leases after expiration of the leases.

In many additional embodiments, the process 500 can determine whether renewal of the leases is successful (block 570). In some embodiments, the process 500 may loop back to block 510 for reinitializing the lease when the renewal of the lease fails. In certain embodiments, the process 500 can loop back to block 570 and continue implementation of the lease if the renewal of the lease is successful.

Although a specific embodiment for the process 500 for the state diagram for carrying out the various steps, processes, methods, and operations described herein is discussed with respect to FIG. 5, any of a variety of systems and/or processes may be utilized in accordance with embodiments of the disclosure. For example, the process 500 may decide the lease requests and monitor the existing leases. The elements depicted in FIG. 5 may also be interchangeable with other elements of FIGS. 1-4 and FIGS. 6-8 as required to realize a particularly desired embodiment.

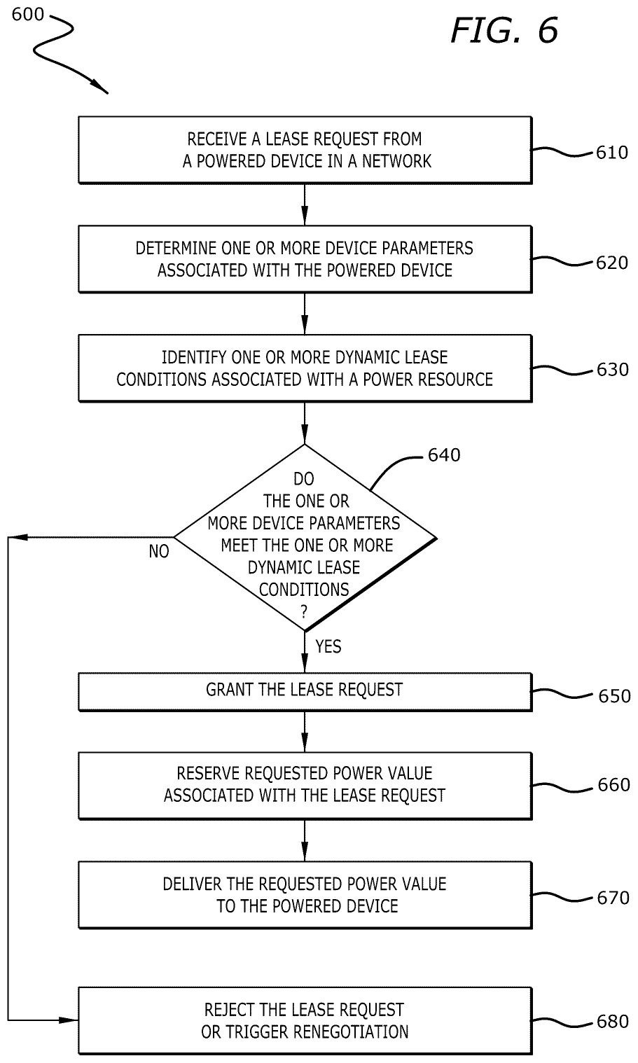

Referring now to FIG. 6, a flowchart depicting a process 600 of granting the lease request, in accordance with various embodiments of the disclosure is shown. In many embodiments, the process 600 can receive the lease request from the powered device in the network (block 610). In some embodiments, the process 600 may determine the one or more requested parameters based on the lease request. In some embodiments, the requested parameters can include the requested power value, the requested power level, or the requested duration of a lease. In some more embodiments, the process 600 can identify the power resource associated with the lease request.

In a number of embodiments, the process 600 may determine one or more device parameters associated with the powered device (block 620). In some embodiments, the lease request may be indicative of one or more of: the requested power value, the requested power level, or the requested lease duration. In certain embodiments, for instance, the requested power value may be indicative of the amount of power requested by the powered device. In more embodiments, the requested power level can be indicative of one or more of: modes of power delivery, or voltage or current levels of power delivery etc. In some more embodiments, the requested lease duration may be indicative of a duration of time for which the powered device requests to lease the power resource, i.e., a duration of time for which the powered device requests to receive power from the power resource. In numerous embodiments, the lease request can be indicative of one or more QoS parameters associated with data transfer or power delivery.

In various embodiments, the process 600 can identify the one or more dynamic lease conditions associated with the power resource (block 630). In some embodiments, the dynamic lease conditions can be indicative of the dynamic threshold priority level, the total available power, the maximum power level, or the maximum duration of the lease. In certain embodiments, the total available power can be indicative of maximum power that the power resource may supply. In more embodiments, the maximum power level may be indicative of power delivery modes supported by the power resource. In some more embodiments, the maximum duration of the lease may be indicative of a maximum time period after which the leases to the power resource may be required to be renewed or renegotiated.

In additional embodiments, the process 600 can check whether the one or more device parameters meet the one or more dynamic lease conditions (block 640). In some embodiments, for example, a first dynamic lease condition may be met if the priority level associated with the powered device is greater than the dynamic threshold priority level. In certain embodiments, for example, a second dynamic lease condition can be met if the requested power value is less than the total available power. In more embodiments, for example, a third dynamic lease condition may be met if the requested power level is less than the maximum power level. In some more embodiments, a fourth dynamic lease condition can be met if the requested lease duration is less than the maximum duration of the lease.

In further embodiments, if at block 640, the process 600 determines that the one or more device parameters meet the one or more dynamic lease conditions, the process 600 can grant the lease request (block 650). In some embodiments, upon grant of the lease request, the process 600 can allocate, reserve, and deliver the requested power value from the power resource for the requested duration of the lease indicated by the lease request. In certain embodiments, the lease may be active for the requested duration of the lease.

In many more embodiments, the process 600 can reserve the requested power value associated with the lease request (block 660). In some embodiments, the requested power value can vary based on an operational mode of the powered device. In certain embodiments, for instance, the process 600 can reserve a higher power value for the powered device during initialization.

In many additional embodiments, the process 600 may deliver the requested power value to the powered device (block 670). In some embodiments, the power may be delivered by way of the combined data/power interface such as the Ethernet ports. In certain embodiments, the power can be delivered by way of POE, PoE+, PoE++, or FMP.

In many further embodiments, if at block 640, the process 600 determines that the one or more device parameters fail to meet the one or more dynamic lease conditions, the process 600 can reject the lease request or trigger renegotiation of the lease request (block 680). In some embodiments, the process 600 can transmit the renegotiation message to the powered device to trigger renegotiation. In more embodiments, the renegotiation message may be transmitted by utilizing one or more network protocols.

Although a specific embodiment for the process 600 for granting the lease request for carrying out the various steps, processes, methods, and operations described herein is discussed with respect to FIG. 6, any of a variety of systems and/or processes may be utilized in accordance with embodiments of the disclosure. For example, the process 600 may also dynamically monitor the granted lease requests. The elements depicted in FIG. 6 may also be interchangeable with other elements of FIGS. 1-5 and FIGS. 7-8 as required to realize a particularly desired embodiment.

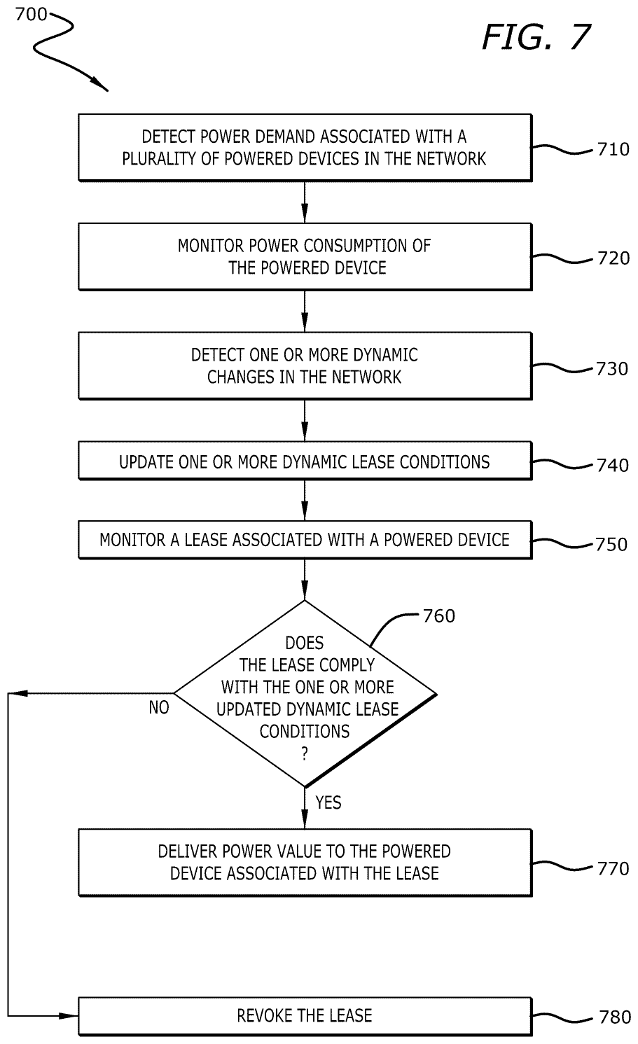

Referring now to FIG. 7, a flowchart depicting a process 700 of monitoring an existing lease, in accordance with various embodiments of the disclosure is shown. In some embodiments, the process 700 can detect power demand associated with the plurality of powered devices in the network (block 710). In some embodiments, the power demand can be indicative of the power required for functioning of the powered devices. In certain embodiments, the process 700 can compare the power demand with the total available power associated with the one or more power resources in the network. In more embodiments, if the power demand exceeds the total available power, the process 700 can detect oversubscription. In some more embodiments, in case of oversubscription, the process 700 can prioritize the powered devices having higher priority levels, and hence, reject the lease requests from the powered devices having lower priority levels.

In a number of embodiments, the process 700 may monitor power consumption of the powered devices (block 720). In some embodiments, the process 700 can receive and analyze telemetry data associated with the powered devices. In certain embodiments, the telemetry data can be indicative of the power consumption of the powered devices. In more embodiments, the telemetry data may be received in real-time or in near-real time. In some more embodiments, the telemetry data can also be received periodically at predetermined intervals. In numerous embodiments, the process 700 may also receive the telemetry data dynamically. In many more embodiments, the process 700 can receive the telemetry data from the powered devices or may retrieve the telemetry data from a database.

In various embodiments, the process 700 can detect one or more dynamic changes in the network (block 730). In some embodiments, the process 700 can detect the dynamic change in the network caused by addition or removal of the powered devices. In certain embodiments, the process 700 may detect some more dynamic changes in the network, such as but not limited to changes in network traffic patterns, hardware failures, or changes in network policies, topology changes, or security events etc. for example.

In additional embodiments, the process 700 may update the one or more dynamic lease conditions (block 740). In some embodiments, the process 700 can update the one or more dynamic lease conditions based on one or more of: the monitored power consumption, the dynamic changes in the network, the detected power demand, or the detected oversubscription. In certain embodiments, upon detecting that the power resources are restrained, the process 700 can update the dynamic threshold priority level to deliver power only to the powered devices that implement network critical functions, for example. In more embodiments, the process 700 may reduce the maximum duration of the lease to grant shorter leases to the power resources, for example.

In further embodiments, the process 700 can monitor the lease associated with the powered device (block 750). In some embodiments, the process 700 may recheck one or more existing leases to determine whether the one or more existing leases are in compliance with the updated dynamic lease conditions. In certain embodiments, the process 700 can check whether one or more existing leases are expired. In more embodiments, the process 700 may also revoke the lease after expiration of the requested duration of the lease indicated by the lease request.

In many more embodiments, the process 700 may check whether the existing leases comply with the one or more updated dynamic lease conditions (block 760). In some embodiments, the process 700 can check whether the device parameters meet the updated dynamic lease conditions. In certain embodiments, the process 700 may monitor the existing leases constantly, dynamically, or periodically.

In many additional embodiments, if at block 760, the process 700 determines that the existing leases comply with the one or more updated dynamic lease conditions, the process 700 can continue the existing lease request (block 770). In that, in some embodiments, the process 700 may continue delivering power to the powered devices as per the existing lease. In certain embodiments, the process 700 can also renegotiate the existing lease based on the updated dynamic lease conditions.

In many further embodiments, if at block 760, the process 700 determines that the existing leases fail to comply with the one or more updated dynamic lease conditions, the process 700 can revoke the existing lease (block 780). In some embodiments, the process 700 may also revoke the lease after expiration of the requested duration of the lease indicated by the lease request. In certain embodiments, the process 700 can revoke the lease based on changes in the network policies.

Although a specific embodiment for the process 700 for monitoring the existing the lease for carrying out the various steps, processes, methods, and operations described herein is discussed with respect to FIG. 7, any of a variety of systems and/or processes may be utilized in accordance with embodiments of the disclosure. For example, the process 700 may dynamically revoke the existing leases. The elements depicted in FIG. 7 may also be interchangeable with other elements of FIGS. 1-6 and FIG. 8 as required to realize a particularly desired embodiment.

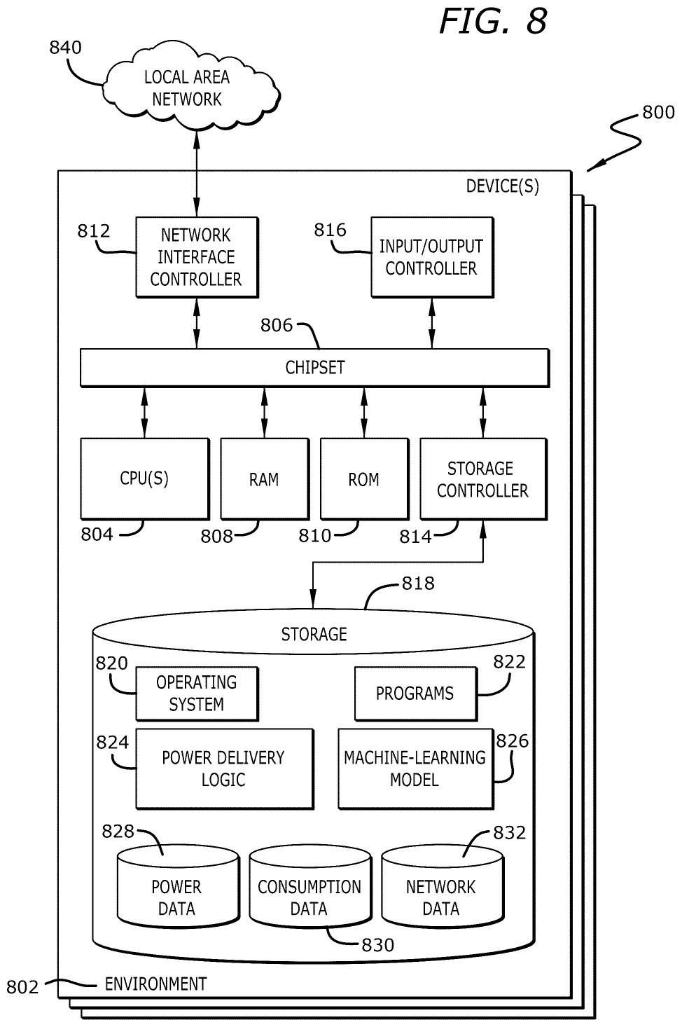

Referring to FIG. 8, a conceptual block diagram of a device 800 suitable for configuration with a power delivery logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, power data 828, consumption data 830, and network data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The power data 828 may store the device parameters, the requested parameters, and the telemetry data associated with the powered devices, for example. The power data 828 can also store information about the existing leases and the received lease requests, for example. The power data 828 may further store the dynamic lease conditions and/or the updated dynamic lease conditions. The consumption data 830 can store the power demand associated with the plurality of powered devices, for example. The network data 832 can store the network policies, network conditions, or information about the dynamic changes in the network, etc., for example.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a power delivery logic 824. The power delivery logic 824 can be configured to perform one or more of the various steps, processes, operations, and/or other methods that are described above. Often, the power delivery logic 824 can be a set of instructions stored within a non-volatile memory that, when executed by the processor(s)/controller(s) 804 can carry out these steps, etc. In some embodiments, the power delivery logic 824 may be a client application that resides on a network-connected device, such as, but not limited to, a server, switch, personal or mobile computing device in a single or distributed arrangement. The power delivery logic 824 may receive the lease requests from the powered devices. The power delivery logic 824 can determine the device parameters associated with the powered devices and the dynamic lease conditions associated with the power resources. The power delivery logic 824 may grant the lease requests if the device parameters and/or the requested parameters meet the dynamic lease conditions. The power delivery logic 824 can deliver power, by way of PoE, to the powered device upon grant of the lease.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the power data 828, the consumption data 830, and the network data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the power delivery logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a power delivery logic that is configured to:
receive a lease request from a powered device in a network;
determine one or more device parameters associated with the powered device;
identify one or more dynamic lease conditions associated with a power resource;
grant the lease request if the one or more device parameters meet the one or more dynamic lease conditions; and
deliver power to the powered device upon grant of the lease request.

2. The device of claim 1, wherein, if the one or more device parameters fail to meet the one or more dynamic lease conditions, the power delivery logic is further configured to:
reject the lease request, or
trigger renegotiation of the lease request with the powered device.

3. The device of claim 1, wherein the lease request is indicative of at least one of: a requested power value, a requested power level, or a requested duration of a lease.

4. The device of claim 3, wherein granting the lease request comprises reserving the requested power value from the power resource for the powered device for the requested duration of the lease.

5. The device of claim 4, wherein the requested power value is at a first power value during initialization of the powered device and the requested power value is at a second power value lower than the first power value after the initialization of the powered device.

6. The device of claim 5, wherein the requested power value is delivered to the powered device at the requested power level for the requested duration of the lease through a combined data/power interface upon the grant of the lease request.

7. The device of claim 6, wherein the combined data/power interface is an Ethernet port and the power is delivered to the powered device by way of Power-over-Ethernet through the Ethernet port.

8. The device of claim 3, wherein the power delivery logic is further configured to:
detect power demand associated with a plurality of powered devices in the network;
monitor power consumption of the powered device; and
detect one or more dynamic changes in the network.

9. The device of claim 8, wherein the power delivery logic is further configured to update the one or more dynamic lease conditions based on at least one of: detected power demand, monitored power consumption, or the one or more dynamic changes in the network.

10. The device of claim 9, wherein the power delivery logic is further configured to revoke the grant of the lease request if the one or more device parameters fail to meet one or more updated dynamic lease conditions.

11. The device of claim 9, wherein the power delivery logic is further configured to revoke the grant of the lease request if the monitored power consumption exceeds the requested power value.

12. The device of claim 8, wherein the one or more device parameters comprise a device priority level associated with the powered device.

13. The device of claim 12, wherein the one or more dynamic lease conditions comprise one or more of: a dynamic threshold priority level, a total available power, a maximum power level, or a maximum duration of the lease.

14. The device of claim 13, wherein a first dynamic lease condition of the one or more dynamic lease conditions is met if the device priority level exceeds the dynamic threshold priority level.

15. The device of claim 14, wherein a second dynamic lease condition of the one or more dynamic lease conditions is met if at least one of:
the requested power level is less than the maximum power level,
the requested power value is less than the total available power, or
the requested duration of the lease is less than the maximum duration of the lease.

16. The device of claim 13, wherein detecting the one or more dynamic changes in the network comprises detecting oversubscription when the power demand exceeds the total available power.

17. The device of claim 13, wherein detecting the one or more dynamic changes in the network comprises detecting at least one of: addition or removal of one or more powered devices in the network.

18. A device, comprising:
a processor; and
a memory communicatively coupled to the processor, wherein the memory comprises a power delivery logic that is configured to:
determine a lease granted to a powered device;
identify a power resource associated with the lease;
determine one or more device parameters associated with the powered device;
identify one or more dynamic lease conditions associated with the power resource; and
determine whether the one or more device parameters meet the one or more dynamic lease conditions.

19. The device of claim 18, wherein, if the one or more device parameters fail to meet the one or more dynamic lease conditions, the power delivery logic is further configured to:
revoke the lease, or
trigger renegotiation of the lease with the powered device.

20. A method, comprising:
receiving a lease request from a powered device in a network;
determining one or more device parameters associated with the powered device;
identifying one or more dynamic lease conditions associated with a power resource;
granting the lease request if the one or more device parameters meet the one or more dynamic lease conditions; and
delivering power to the powered device upon grant of the lease request.
